(19) United States
(12) Patent Application Publication
(10) Pub. No.: US 2005/0120871 A1
(43) Pub. Date: Jun. 9, 2005

(54) Movable stringed instrument pickup system

(76) Inventor: Michael Sebastian Spalt, Los Angeles, CA (US)

Correspondence Address: MICHAEL SPALT, 1316 MANZANITA ST., LOS ANGELES, CA, 90027, US

(21) Appl. No.: 10/728,250

(22) Filed: Dec. 4, 2003

(51) Int. Cl. G10H 1/32; G10H 3/00

(52) U.S. Cl. 84/743

(57) ABSTRACT

A movable pickup mounting system is disclosed, which consists of a “wiper” arm and thereupon mounted electromagnetic pickup unit, movably attached to the body of the stringed instrument, to provide a means of moving the pickup through different positions along the string path and thus achieve different tonal effects.

This application claims benefit of the Provisional Patent Application received by USPTO Mail center on Dec. 9^{th}, 2002 Serial No. unknown

### BACKGROUND OF THE INVENTION

1. Field of Invention

This invention relates to stringed musical instruments in general and electric guitars and basses having a movable pickup system in particular.

2. Prior Art

Several designs for movable pickups have been disclosed in the past. Some designs are for slideable pickups, some for rotateable. The general purpose is to position the pickup along different sections of the vibrating string and thus effect a change in the sound quality of the instrument. The closer a pickup is to the bridge of a stringed instrument, the more it will pick up treble frequencies. As it is moved closer to the neck part of the instrument it will increasingly favor bass response. Furthermore, there are along the vibrating string so-called “harmonic nodes”, locations where the harmonic content of the plucked note is emphasized. These are called “sweet spots”. Depending on scale length, tuning and the actual note played these sweet spots vary. A movable pickup can be placed in the optimal location to capture the desired tonal characteristic. A two- or three-pickup instrument attempts to capture these varying characteristics but is limited a) by the fixed location of the pickups, and b) to achieve “in between” sounds, output from two pickups has to be electronically mixed, resulting in phase shifts (since the two pickups simultaneously record a slightly different waveform of the vibrating string). These disadvantages have led to development of movable pickup mounting designs.

Slideable pickup mounting designs have the advantage of more effectively shaping the tonal characteristics of the instrument by allowing placement of the pickup at relatively more distant locations along the string path. Rotateable designs place the pickups at different angles relative to the string path, which results in subtle shifts in tone, or as is the case in Pagelli 716, interesting tonal effects which however do not find widespread use or acceptance. Each of the designs in the prior art either exhibit deficiencies which this new design overcomes, or are meant to produce a different effect from the one produced by this design. Most slideable designs are cumbersome in use and prone to mechanical failure in the field while rotateable designs are severely limited in the range of tonal manipulation they offer.

Some References:

| | |
|---|---|
| 3,780,202 | Clement R. Law |
| 3,911,777 | Rendell |
| 4,261,240 | Aaroe |
| 5,012,716 | Claudio Pagelli |

Field of Search: 84/723
84/1725-729
84/743

### SUMMARY OF THE INVENTION

The object of the present invention is to provide the most useful and broad changes in the tonal spectrum of a musical stringed instrument, while maintaining a simple and effective mechanism, which can be manufactured at low cost and will remain trouble free and is easy to operate. In this preferred structural embodiment the instrument is an electric bass.

The present invention includes an electromagnetic pickup, which is mounted on a pivoting arm, constituting an assembly, which in turn is movably affixed to the guitar body at one end. The pickup can thus be moved, in a “wiping” fashion, describing an arc, substantially coplanar with the path of the strings, along the length of the strings, thus picking up different tonal characteristics depending on its position. The “wiper arm” is fitted with means of mounting the pickup, and the connecting wire runs from the pickup through a channel in the wiper arm to a respective channel routed into the body near the pivot point of the wiper arm, so that it remains flexibly connected at all times to the electronics cavity in the guitar or bass body. In this preferred embodiment an adjustable screw with friction washers is used as pivot point and anchor for the wiper arm. The frictional force exerted by the screw determines the ease with which the wiper arm may be moved and will cause the arm to stop and remain in the position selected.

### BRIEF DESCRIPTION OF THE DRAWINGS

Page 1

FIG. 1 is a front view of the pickup/wiper arm assembly situated on the body of a bass guitar.

The pickup 1 is mounted to the wiper arm 2, which is movably attached to the body of the instrument 3 by the pivot screw 4. The strings 5 are connected on one end to the bridge 6, at the other end to the headstock 7 of the instrument. The instrument may be provided with tone and volume controls 8 and with an output jack 9 for connection to an amplifier.

FIG. 2 is a side view of the pickup/wiper arm assembly

The pickup 1 is affixed to the wiper arm 2 by means of screws or other fastening devices 10. The connecting wire 11 issues from an opening at the base of the wiper arm 2

Page 2

FIG. 3 is a top view of the wiper arm assembly with the wire connecting the pickup to the body cavity

The pickup connector wire 11 runs through a channel 12 in the wiper arm 2 to a respective channel 13 routed into the body of the instrument 3, allowing for sufficient flex in the wire 11.

FIG. 4 is a side cut-away view of the pivot screw attachment and wiper arm assembly

The wiper arm 2 is moveably mounted to the body of the instrument 3 by means of the pivot screw 4. The friction washers 14 and 15 allow variable pressure to be exerted and the achievement of variations in the ease of movement of the wiper arm 2. The countersunk insert 16 in the body provides a permanent and durable means of attachment for the pivot screw 4

FIG. 5 is a side cut-away illustrating the slanting sliding plane as the pickup moves towards or away from the bridge

The plane of the sliding surface 17 of the musical instrument body 3 for the wiper arm 2 is lightly sloped. Position 17A is closer to the strings than position 17B, thus compensating for the increase in volume as the pickup travels from position 17A towards position 17B.

### DETAILED DESCRIPTION OF THE PREFERRED EMBODIMENT

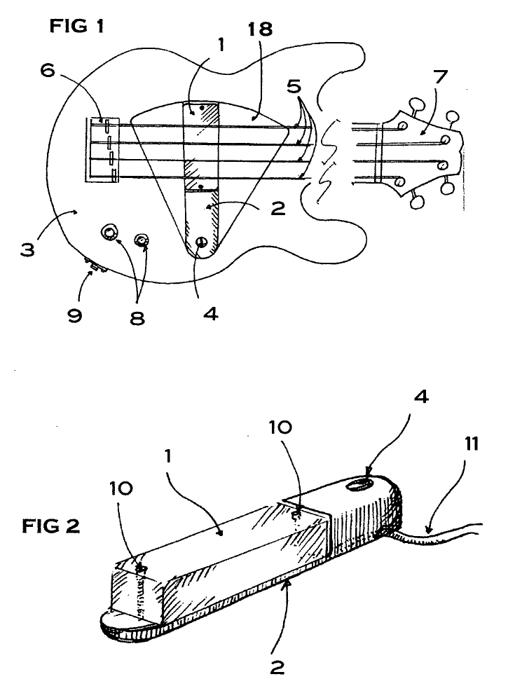

A top view of an electric stringed musical instrument, in this preferred embodiment a 4-string bass guitar, is shown in FIG. 1, having a neck and headstock with tuning mechanisms 7, strings 5 which are anchored to the body 3 by the bridge 6. The pickup 1 is shown mounted on the “wiper” arm 2, in this preferred embodiment attached to the body of the instrument 3 by a screw 4. The pickup may be moved back and forth in the pie-shaped recess 18 routed into the body 3. The recess 18 defines the range of movement available to the wiper arm 2. It also allows the assembly of wiper 2 and pickup 1 to be nearly flush with the top of instrument body 3, thus preventing it from interfering with the musician's playing. While playing, the musician may use his thumb placed on the top end of the pickup 1 farthest from the pivot point 4 to easily alter the position of the pickup 1. Adjustment of the screw 4 will result in more or less friction being applied to the wiper arm 2, thus enabling the musician to select the proper tension for his playing style. He may also find a “sweet spot” and tighten the pivot screw 4 to maintain the pickup 1 and wiper arm 2 permanently in the desired position. Additionally the pickup 1 will provide the musician with a “thumbrest” in the appropriate playing position for the respective tonality desired. Specifically, a bass player's hand will move closer to the bridge 6 when brighter sounds are desired, corresponding to the position of the pickup 1 and wiper arm 2, or conversely, closer to the neck 7 for warmer tones. The range of movement of the pickup 1 covers most of the commonly desirable positions and additionally allows for an almost infinite number of alternate positions. It has been found that the present invention greatly enhances the versatility and usefulness of a standard stringed musical instrument by enabling the musician to tailor the sound quickly and effectively to his playing style.

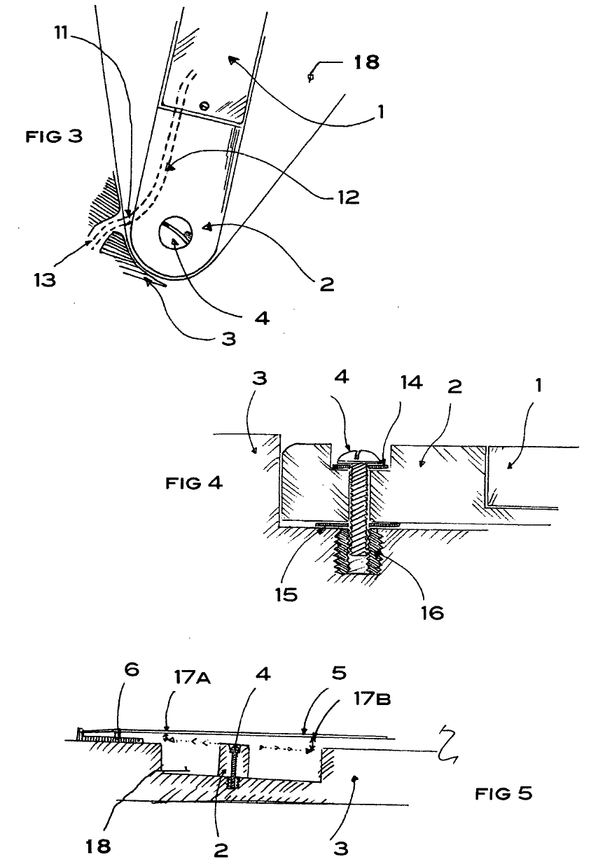

FIG. 2 shows a view of the wiper arm 2 with attached pickup 1 assembly. By means of the screws 10 which affix the pickup to the wiper arm 2 and internally located springs 19 which exert upward pressure to counteract the downward pressure of the screws 10, the pickup 1 can be raised or lowered respective to the wiper arm 2 so as to allow for proper adjustment of the ideal string-to-pickup distance. As can be seen in FIG. 3, the cable 11 runs from the pickup 1 in a groove 12 at the bottom of the wiper arm 2, exits near the pivot point 4 and enters the body of the instrument 3 by means of the opening 13.

FIG. 4 shows a cutaway of the wiper arm 2 with the tensioning screw 4 in the preferred embodiment. Alternately a thumb screw or other screw design may be substituted, the main objective being to provide friction which causes the wiper arm to remain in the selected position and to adjust such friction quickly and effectively during use of the instrument. Washers 14 and 15 allow the wiper arm 2 to move while retaining the screw 4 in its position in the bushing or anchor 16 which is affixed into the instrument body 3.

The simplicity of the design allows for easy manufacture and maintenance and provides an effective means of shaping the tone of the instrument “on the fly”.

Furthermore, the arc of the wiper arm's 2 path may be designed so as to angle the pickup 1 more or less respective to the string path, thus producing more or less extreme tonal effects. Also the wiper arm 2 may be longer or shorter and thus effect subtle changes in the geometry of the sensing arc, any of which may be deemed more desirable in some particular instance. In addition the plane of the wiper's arm 2 arc is lightly sloped respective to the string path, so as to position the pickup progressively closer to the strings as it moves towards the bridge, thus counteracting the diminution in volume effected by the reduced vibrational energy exerted by the strings in proximity of the bridge. FIG. 5 illustrates a cutaway view of the instrument body 3 with the recess 18 routed in such a way as to create a slope, placing the pickup 1 closer to the strings 5 at the endpoint of the arc 17A near the bridge 6, thus counteracting the diminuition of string energy encountered near the “witness” point at the bridge 6. As the wiper 4 with pickup 1 is moved closer to the neck of the instrument, increased vibrational energy from the strings 5 will cause the volume output to rise. This is counteracted by placing the wiper and pickup further from the strings 5 at the end point of the arc 17B.

In summary, the present device opens a wide range of possibilities which is not possible with conventional pickup attachments or with the pickup-head devices disclosed in the background of the invention. The foregoing description and drawings merely explain and illustrate the invention, and the invention is not limited thereto except insofar as those who have the disclosure before them are able to make modifications and variations therein without departing from the scope of the invention.

1. A manually moveable electromagnetic pickup assembly for sensing vibrations in a musical instrument, said device comprising: A manually moveable arm provided with means of mounting an electromagnetic pickup thereupon, moveably attached at one end to the body of the musical instrument;
means for rotateably mounting said assembly to the body of said musical instrument comprising of a pivot shaft screw attached to said musical instrument body by means of a bushing or anchor;
means for adjusting the frictional engagement of said assembly with the body of said instrument comprising said adjustable pivot shaft screw;
means for defining the arc described by said assembly on the body of said musical instrument;
means for defining the plane of the arc described by said assembly respective to the string plane.

2. The manually moveable pickup assembly of claim 1, wherein said means for selectively adjusting the frictional force of the pivot shaft of said assembly comprises:
means on said screw shaft member for frictional engagement with said bushing or anchor member so as to retard or stop the rotational movement of said moveable pickup assembly.

3. The device of claim 1, wherein the arc described by said pickup assembly is defined by a routed guide cavity in the body of said instrument, thereby limiting the travel of said assembly and defining the arc of its travel.

4. The device of claim 3, wherein the bottom of said routed guide cavity is sloped in relation to the string plane, placing said moveable pickup assembly closer to the strings near the bridge of said instrument.

5. An electric stringed instrument comprising:
an instrument body;
a plurality of strings mounted on said body;
a manually moveable wiper and electromagnetic pickup assembly allowing movement of said assembly to a plurality of desired positions;
means of moveably mounting said assembly on said musical instrument;
means of adjusting the friction of said movement and of fixing said assembly in the desired position;
means for electrically connecting said electromagnetic pickup to an amplifier.
